(19) United States
(12) Patent Application Publication
(10) Pub. No.: US 2014/0240651 A1
(43) Pub. Date: Aug. 28, 2014

(54) LIQUID CRYSTAL DISPLAY PANEL AND LIQUID CRYSTAL DISPLAY DEVICE

(71) Applicant: Sharp Kabushiki Kaisha, Osaka-shi, Osaka (JP)

(72) Inventors: Takatomo Yoshioka, Osaka-shi (JP); Yuichi Iyama, Osaka-shi (JP); Kazuhiko Tsuda, Osaka-shi (JP)

(73) Assignee: Sharp Kabushiki Kaisha, Osaka-shi, Osaka (JP)

(21) Appl. No.: 14/351,989

(22) PCT Filed: Oct. 11, 2012
(86) PCT No.: PCT/JP2012/076267

§ 371 Date: Apr. 15, 2014

(30) Foreign Application Priority Data
Oct. 18, 2011 (JP) 2011-229221

(51) Int. Cl. G02F 1/1343

(52) U.S. Cl. CPC G02F 1/134363; G02F 2001/134318
USPC 349/141

(57) ABSTRACT

The present invention provides a liquid crystal display panel and a liquid crystal display device that can provide a sufficiently high response speed and an excellent transmittance and reduce flexoelectricity so as to achieve excellent display quality. A liquid crystal display panel of the present invention is a liquid crystal panel including a first substrate including a dielectric layer, and a second substrate including an electrode, the electrode including an electrode to generate a transverse electric field and a slit-formed electrode.

### TECHNICAL FIELD

The present invention relates to a liquid crystal display panel and a liquid crystal display device. More specifically, the present invention relates to a liquid crystal display panel and a liquid crystal display device that control the alignment of liquid crystal molecules by a transverse electric field.

### BACKGROUND ART

A liquid crystal display panel includes a pair of glass substrates and a liquid crystal display element disposed therebetween. Owing to its characteristics, including a thin profile, a light weight, and a low power consumption, such a liquid crystal display panel is indispensable in everyday life and business as a display panel for devices including personal computers, televisions, onboard devices such as automotive navigation systems, personal digital assistants such as mobile phones, and display devices capable of performing stereoscopic display. In these applications, persons skilled in the art have studied liquid crystal display panels of various modes with different electrode arrangements and different substrate designs for changing the optical characteristics of the liquid crystal layer.

Examples of the display modes of current liquid crystal display devices in recent years include: a vertical alignment (VA) mode in which liquid crystal molecules having negative anisotropy of dielectric constant are aligned vertically to the substrate surface; an in-plane switching (IPS) mode and a fringe field switching (FFS) mode in which liquid crystal molecules having positive or negative anisotropy of dielectric constant are aligned horizontally to the substrate surface and a transverse electric field is applied to the liquid crystal layer.

One document discloses, as a FFS-driving liquid crystal display device, a thin-film-transistor liquid crystal display having a high response speed and a wide viewing angle. The device includes: a first substrate having a first common electrode layer; a second substrate having a pixel electrode layer and a second common electrode layer; a liquid crystal disposed between the first substrate and the second substrate; and a means for generating an electric field between the first common electrode layer of the first substrate and both of the pixel electrode layer and the second common electrode layer of the second substrate so as to provide a high response speed to a high input-data-transfer rate and a wide viewing angle for a viewer (for example, see Patent Literature 1).

Another document discloses, as a liquid crystal device with multiple electrodes applying a transverse electric field, a liquid crystal device including a pair of substrates opposite to each other; a liquid crystal layer which includes liquid crystal having positive anisotropy of dielectric constant and which is disposed between the substrates; electrodes which are provided to the respective first and second substrates constituting the pair of substrates, facing each other with the liquid crystal layer therebetween, and which apply a vertical electric field to the liquid crystal layer; and multiple electrodes for applying a transverse electric field to the liquid crystal layer disposed in the second substrate (for example, see Patent Literature 2).

### CITATION LIST

### Patent Literature

Patent Literature 1: JP 2006-523850 T

Patent Literature 2: JP 2002-365657 A

### SUMMARY OF INVENTION

### Technical Problem

For example, in a liquid crystal display device or the like including a vertical-alignment three-layered electrode structure, when an upper comb-shaped electrode generates a transverse electric field, a liquid crystal includes a region serving as a bend alignment or a spray alignment. For this reason, flexoelectricity is caused by a flexoelectric effect, the polarities of voltages applied to the upper comb-shaped electrode and a lower electrode are inverted to cause the difference between transmittances and the difference between response speeds to occur. More specifically, a flicker occurs in application of positive and negative voltages equal to each other, i.e., in polarity inversion to deteriorate display quality. An offset is applied to the voltages to make it possible to avoid the difference between transmittances from occurring. However, DC (Direct current) image sticking disadvantageously occurs.

In use of a pair of comb-shaped electrodes, in a mode for determining an alignment of liquid crystal by a transverse electric field, a spray alignment or a bend alignment occurs because the liquid crystal is obliquely aligned. When such an alignment occurs, the symmetry of the alignment of liquid crystal molecules breaks down to cause macroscopic polarization (flexoelectricity) to occur. The flexoelectricity is a phenomenon appearing regardless of the shapes of liquid crystal molecules.

When the flexoelectricity occurs, alignments are different from each other by inversion of positive and negative polarities. For this reason, the transmittances are different from each other. Furthermore, the response speeds are different from each other. In particular, the present inventors have found that a liquid crystal display device including a vertical-alignment three-layered electrode structure is configured by a pair of comb-shaped electrodes and a lower electrode in a TFT substrate and a counter electrode in a counter substrate, so that liquid crystal molecules are rotated in rising by a transverse electric field acting between upper electrodes and rotated in falling by a vertical electric field generated by the potential difference between the substrates to make it possible to achieve a high response speed. However, not only the transverse electric field generated by the comb-shaped electrodes on the upper layer but also vertical pulling of a line of electric force caused by the counter electrode and the lower electrode exists, thereby a spray alignment easily occurs in a large area, and the flexoelectricity considerably influences the liquid crystal. In the liquid crystal display device including a vertical-alignment three-layered electrode structure, flexoelectricity inevitably occurs in a mode for determining an alignment of liquid crystal by a transverse electric field using a pair of comb-shaped electrodes. For this reason, an approach to suppress the drawback is necessary.

In the invention described in Japanese Patent Application No. 2011-142350, in a liquid crystal display device including a vertical-alignment three-layered electrode structure, liquid crystal molecules are rotated in rising by a transverse electric field acting between upper electrodes and rotated in falling by a vertical electric field generated by the potential difference between substrates to make it possible to achieve a high response speed. When the lower electrode includes a slit, a transmittance higher than that obtained when a planar lower electrode being free from an alignment-controlling structure can be obtained. As a method of applying a voltage, a method that causes an upper electrode and a lower electrode to have equal potentials has been described. However, a voltage set value is not mentioned. Furthermore, addition of an overcoat layer (also called an OC layer or a dielectric layer) is not described.

Japanese Patent Application No. 2011-142350 does not specially mention a reduction of flexoelectricity. However, as described above, since an influence of the flexoelectricity on a flicker or DC image sticking is concerned in using of the mode, a structure or drive to reduce the flexoelectricity is required.

Basically, unless the flexoelectricity is considered, by the influence of the flexoelectricity, the difference between alignments of liquid crystal molecules caused by inversion of the negative and positive polarities of drive voltages and the difference between transmittances caused by the difference between alignments occur and appear as a flicker.

The present invention is devised in view of the above situation, and aims to provide a liquid crystal display panel and a liquid crystal display device including a three-layered electrode structure that controls the alignment of the liquid crystal molecules by an electric field in both of rising and falling, which are capable of providing a sufficiently high response speed and an excellent transmittance and reducing flexoelectricity to make it possible to obtain excellent display quality.

### Solution to Problem

The present inventors have performed studies for providing a high response speed and a high transmittance together in a vertical-alignment liquid crystal display panel and liquid crystal display device, and thereby have focused on a three-layered electrode structure which controls the alignment of the liquid crystal molecules by an electric field in both rising and falling. The present inventors have found that, in the vertical-alignment three-layered electrode structure, an overcoat layer is formed on the counter substrate side and a slit structure (will be described later) as shown in FIG. 3 is given to the lower electrode of the other substrate, and found that a voltage of the lower electrode (iii) is set to a value largely different from that of a counter electrode (iv). In the present invention, it has been found that the electrode structure, the layer configuration, and the drive voltage setting can suppress the influence of flexoelectricity. In FIG. 3, an upper comb-shaped electrode (ii) that does not overlap the lower electrode in a plan view of the main surface of the substrate and the lower electrode (iii) may have equal potentials or different potentials. However, when the electrodes have equal potentials, one TFT can be cut out. For this reason, an aperture ratio is increased to advantageously simplify driving.

The present inventors have found that an overcoat layer is formed on the counter electrode (iv) side to reduce a cell thickness so as to make it possible not only to make a viewing angle characteristic or the like excellent but also to make the balance of vertical pulling of lines of electric force of the lower electrode (iii) and the counter electrode (iv) appropriate.

Furthermore, a slit is formed in the lower electrode to pull a line of electric force near an end (edge) of the upper comb-shaped electrode (i) almost downward, and the remaining line of electric force is easily pulled toward the upper comb-shaped electrode (ii) and becomes horizontal to the main surface of the substrate. In this manner, the present inventors have found that as a result of driving the device to generate a line of electric force that has been obliquely generated in one of a vertical direction and a horizontal direction as far as possible, a spray alignment is decreased to reduce an influence by flexoelectricity.

The present inventors have further studied an electrode structure and have found that, in the method of using a slit-less planar electrode as a conventional lower electrode, a transverse electric field is shielded because a line of electric force is strongly pulled downward in a large area in rising (on state) so as to disadvantageously increase a region of spray alignment. The present inventors have found the following. That is, especially in comb-shaped electrode driving, a slit is also formed in the lower electrode to control a line of electric force pulled downward when a planar electrode is used as the lower electrode so as to improve a transmittance in rising, a region of spray alignment is reduced to prevent a flicker from occurring so as to make it possible to improve display quality and to also prevent DC image sticking, and the problem described above can be sufficiently solved. Furthermore, the present inventors have found that the present invention that is a liquid crystal display panel in which a first substrate includes a dielectric layer, a second substrate includes an electrode, the electrode includes an electrode to generate a transverse electric field and a slit-formed electrode can exert the effect of the present invention and have conceived the present invention.

A field sequential driving liquid crystal display device or a liquid crystal display device used in a low-temperature environment has a problem in a response speed that is especially conspicuous. The present invention can solve the problem, and display quality can be made excellent.

JP 2006-523850 T and JP 2002-365657 A that are Patent Literatures serving as the citation list described above do not describe any method of forming a slit in a lower electrode and do not describe the followings. That is, an overcoat layer is formed in a counter substrate, a lower electrode of a TFT substrate is configured to include a slit, and the configuration considerably reduce flexoelectricity to improve display quality.

In other words, the present invention relates to a liquid crystal display panel including a first substrate, a second substrate, and a liquid crystal layer disposed between the substrates, wherein the first substrate includes a dielectric layer, and the second substrate includes an electrode, and the electrode includes an electrode to generate a transverse electric field and a slit-formed electrode.

The transverse electric field means an electric field horizontal to the main surface of the substrate. The liquid crystal display panel of the present invention is to normally generate the horizontal electric field to perform a white display. As the electrode to generate the transverse electric field, a pair of comb-shaped electrodes are preferably used. More specifically, although the transverse electric field may be an electric field including a horizontal component such as a fringe electric field generated between the upper electrode and the lower electrode of the substrate, a transverse electric field generated between a pair of comb-shaped electrodes (more specifically, a pair of comb-shaped electrodes disposed on the same layer) is preferably used.

The “slit-formed electrode” herein is at least regarded as including a slit in the technical field of the present invention. The slit may be formed such that the portions surrounding the slit of the electrode are electrically connected into one part, or may be formed so as to divide the portion surrounding the slit of the electrode into two or more portions without electric connection. The slit-formed electrode may partially include a planar region including no slit as long as it is capable of providing the effects of the present invention.

The slit-formed electrode preferably overlaps at least one of the pair of comb-shaped electrodes in a plan view of main surfaces of the substrates. In this manner, the flexoelectricity can be more sufficiently reduced. The slit-formed electrode more preferably overlaps one of the pair of comb-shaped electrodes but does not overlap the other of the pair of comb-shaped electrodes in a plan view of the main surfaces of the substrates. In general, in generation of a transverse electric field, a voltage of the comb-shaped electrode that does not overlap the slit-formed electrode is set to be substantially equal to a voltage of the slit-formed electrode, a voltage of the comb-shaped electrode that overlaps the slit-formed electrode is set to be lower than the voltage of the comb-shaped electrode that does not overlap the slit-formed electrode and the voltage of the slit-formed electrode to conspicuously exert an effect of pulling a line of electric force. The slit-formed electrode preferably protrudes (extends) from at least one of the pair of comb-shaped electrodes in a plan view of the main surfaces of the substrates.

The at least one of the pair of comb-shaped electrodes is preferably electrically connected with the slit-formed electrode. The comb-shaped electrode which does not overlap the slit-formed electrode in a plan view of the main surfaces of the substrates is preferably electrically connected with the slit-formed electrode. Furthermore, the number of driving TFTs per picture element is particularly preferably two or less.

The slit-formed electrode may not overlap the pair of comb-shaped electrodes in a plan view of the main surfaces of the substrates, or may overlap both of the pair of comb-shaped electrodes. However, as described above, the slit-formed electrode preferably overlaps one of the pair of comb-shaped electrodes but does not overlap the other of the pair of comb-shaped electrodes.

At least part of an edge of the slit-formed electrode preferably does not overlap the pair of comb-shaped electrodes in a plan view of the main surfaces of the substrates.

The slit-formed electrode preferably exists on a layer different from the layer on which the electrode (more preferably, the pair of comb-shaped electrodes) to generate the transverse electric field exists. A slit-formed planar electrode is usually formed such that it interposes an electrically resistant layer with the pair of comb-shaped electrodes. The electrically resistant layer is preferably an insulating layer. The “insulating layer” herein is at least regarded as an insulating layer in the technical field of the present invention. Furthermore, in order to provide the effects of the present invention, the pair of comb-shaped electrodes of the lower substrate are preferably upper electrodes of the liquid crystal layers side, and the slit-formed electrode of the lower substrate is preferably a lower electrode on a side opposite to the liquid crystal layer side. However, the upper electrode may be a slit-formed electrode, and the lower electrodes are the pair of comb-shaped electrodes.

The pair of comb-shaped electrodes at least satisfies that two comb-shaped electrodes are disposed opposite to each other in a plan view of the main surfaces of the substrates. This pair of comb-shaped electrodes suitably generates a transverse electric field therebetween. With a liquid crystal layer including liquid crystal molecules having positive anisotropy of dielectric constant, the response performance and the transmittance are excellent in rising. With a liquid crystal layer including liquid crystal molecules having negative anisotropy of dielectric constant, the liquid crystal molecules are rotated by a transverse electric field to provide a high response speed in falling. The electrodes of the first substrate and the second substrate at least provide the potential difference between the substrates. This generates a vertical electric field by the potential difference between the substrates in falling with a liquid crystal layer including liquid crystal molecules having positive anisotropy of dielectric constant and in rising with a liquid crystal layer including liquid crystal molecules having negative anisotropy of dielectric constant, and rotates the liquid crystal molecules by the electric field to provide a high response speed.

The pair of comb-shaped electrodes may exist on the same layer or the pair of comb-shaped electrodes may exist on different layers as long as it provides the effects of the present invention. The pair of comb-shaped electrodes preferably exist on the same layer. The phrase “the pair of comb-shaped electrodes exist on the same layer” and its derivative forms herein mean that the comb-shaped electrodes are in contact with the same component (e.g. insulating layer, liquid crystal layer, or the like) on the liquid crystal layer side and/or the side opposite to the liquid crystal layer side.

The pair of comb-shaped electrodes preferably satisfies that the tooth portions are along each other in a plan view of the main surfaces of the substrates. Particularly preferably, the tooth portions of the pair of comb-shaped electrodes are substantially parallel with each other, in other words, each of the comb-shaped electrodes includes multiple substantially parallel slits.

In order to make a response speed sufficiently high in falling, a thickness d_{oc} of the dielectric layer is preferably decreased. For example, the thickness d_{oc} of the dielectric layer is preferably 3.5 μm or less. The thickness d_{oc} is more preferably 2 μm or less. The lower limit is preferably 1 μm or more. In terms of an increase in response speed in falling, a dielectric constant ε_{oc} of the dielectric layer is also preferably increased. For example, the dielectric constant ε_{oc} of the dielectric layer is preferably 3.0 or more. The upper limit is preferably 9 or less.

The liquid crystal layer preferably includes liquid crystal molecules which are aligned in the vertical direction to the main surfaces of the substrates at a voltage lower than a threshold voltage. The phrase “aligned in the vertical direction to the main surfaces of the substrates” and its derivative forms herein at least satisfy the state regarded as being aligned in the vertical direction to the main surfaces of the substrates in the technical field of the present invention, including a mode of alignment in the substantially vertical direction. The liquid crystal molecules in the liquid crystal layer preferably are substantially constituted by liquid crystal molecules aligned in the vertical direction to the main surfaces of the substrates at a voltage less than a threshold voltage. Such a vertical-alignment liquid crystal display panel is advantageous to provide characteristics such as a wide viewing angle and a high contrast, and its application range is widened.

The liquid crystal layer is preferably configured by nematic liquid crystal to provide the operational effects of the present invention.

The pair of comb-shaped electrodes preferably has different electric potentials at a threshold voltage or higher. The threshold voltage means a voltage value that provides a transmittance of 5% with the transmittance in the bright state defined as 100%, for example. The phrase “have different electric potentials at a threshold voltage or higher” and its derivative forms herein at least means that a driving operation that generates different electric potentials at a threshold voltage or higher can be implemented. This makes it possible to suitably control the electric field applied to the liquid crystal layer. The upper limit of each of the different electric potentials is preferably 20 V, for example. Examples of a structure for providing different electric potentials include a structure in which one comb-shaped electrode of the pair of comb-shaped electrodes is driven by a certain TFT while the other comb-shaped electrode is driven by another TFT or the other comb-shaped electrode communicates with the lower electrode disposed below the other comb-shaped electrode. This structure makes it possible to provide different electric potentials to the pair of comb-shaped electrodes, respectively. The width of each tooth portion of the pair of comb-shaped electrodes is preferably 2 μm or greater, for example. The gap (length of the space) between tooth portions is preferably 2 to 7 μm, for example.

The first substrate preferably further includes an electrode. The electrode of the first substrate is preferably a planar electrode. The term “planar electrode” herein includes a mode in which multiple electrode portions of multiple pixels are electrically connected. Preferable examples of such a mode of the planar electrode of the first substrate include a mode in which electrode portions of all the pixels are electrically connected and a mode in which electrode portions in each same pixel line are electrically connected.

Furthermore, the liquid crystal display panel is preferably arranged such that the liquid crystal molecules in the liquid crystal layer are aligned in the vertical direction to the main surfaces of the substrates by an electric field generated between the pair of comb-shaped electrodes or between the first substrate and the second substrate. This makes it possible to suitably apply a vertical electric field to provide a high response speed. In particular, the electrode of the first substrate which is a planar electrode makes it possible to suitably generate a vertical electric field by the potential difference between the substrates in falling, thereby providing a high response speed. The electrode of the first substrate is usually disposed on the liquid crystal layer side of a glass substrate. Still, it may be disposed on the side opposite to the liquid crystal layer side of the glass substrate (viewer side).

For suitable application of a transverse electric field and a vertical electric field, particularly preferably, the electrodes (upper electrodes) at the liquid crystal layer side of the second substrate constitute a pair of comb-shaped electrodes to generate a transverse electric field, and the electrode (lower electrode) opposite to the liquid crystal layer side of the second substrate is a slit-formed electrode. For example, the slit-formed electrode may be disposed on the layer (the layer in the second substrate opposite to the liquid crystal layer) below the pair of comb-shaped electrodes of the second substrate with an insulating layer interposed therebetween.

The “planar electrode” of the first substrate herein at least satisfies the state regarded as having a planar shape in the technical field of the present invention, and may include an alignment-controlling structure such as a rib or a slit in a certain region or may include such an alignment-controlling structure at the center portion of a pixel in a plan view of the main surfaces of the substrates. Still, preferably, the planar electrode includes substantially no alignment-controlling structure.

The slit-formed electrode of the second substrate may include a rib, for example, in a certain region. Still, preferably, the slit-formed electrode includes substantially only a slit and the portion including no slit has a planar shape.

The liquid crystal layer is usually aligned by an electric field generated between the pair of comb-shaped electrodes or between the first substrate and the second substrate so that it contains a component horizontal to the main surfaces of the substrates at a threshold voltage or higher. In particular, the liquid crystal molecules preferably include those aligned in the horizontal direction. The phrase “aligned in the horizontal direction” and its derivative forms herein at least satisfy the state regarded as being aligned in the horizontal direction in the technical field of the present invention. This makes it possible to improve the transmittance. The liquid crystal molecules in the liquid crystal layer are preferably substantially constituted by liquid crystal molecules aligned in the horizontal direction to the main surfaces of the substrates at a threshold voltage or higher.

The liquid crystal layer preferably includes liquid crystal molecules having positive anisotropy of dielectric constant (positive-type liquid crystal molecules). The liquid crystal molecules having positive anisotropy of dielectric constant are aligned in a certain direction when an electric field is applied, and the liquid crystal molecules are easily controlled in alignment to make it possible to provide a higher response speed. The liquid crystal layer also preferably includes liquid crystal molecules having negative anisotropy of dielectric constant (negative-type liquid crystal molecules). This makes it possible to further improve the transmittance. In other words, from the viewpoint of a high response speed, the liquid crystal molecules are preferably substantially constituted by liquid crystal molecules having positive anisotropy of dielectric constant. From the viewpoint of transmittance, the liquid crystal molecules are preferably substantially constituted by liquid crystal molecules having negative anisotropy of dielectric constant.

At least one of the first substrate and the second substrate usually includes an alignment film on the liquid crystal layer side. The alignment film is preferably a vertical alignment film. Examples of the alignment film include alignment films formed from organic material or inorganic material, and photo-alignment films formed from photoactive material. The alignment film may be an alignment film without any alignment treatment such as rubbing. Alignment films formed from organic or inorganic material and photo-alignment films each requiring no alignment treatment enable simplification of the process to reduce the cost, as well as improvement in the reliability and the yield. If an alignment film is subjected to rubbing, the rubbing may cause disadvantages such as liquid crystal contamination due to impurities from rubbing cloth, dot defects due to contaminants, and display unevenness due to uneven rubbing in liquid crystal panel. On the contrary, alignment films formed from organic or inorganic material and photo-alignment films can eliminate these disadvantages. At least one of the first substrate and the second substrate preferably includes a polarizing plate on the side opposite to the liquid crystal layer. The polarizing plate is preferably a circularly polarizing plate. This makes it possible to further improve the transmittance. The polarizing plate may also preferably be a linearly polarizing plate. This makes it possible to give excellent viewing angle characteristics.

The liquid crystal display panel of the present invention usually generates the potential difference at least between an electrode of the first substrate and an electrode of the second substrate (e.g. the planar electrode of the first substrate and the slit-formed electrode of the second substrate) when a vertical electric field is generated. A preferable mode thereof is such that the higher potential difference is generated between the electrode of the first substrate and the electrode of the second substrate than that between electrodes (e.g. the pair of comb-shaped electrodes) of the second substrate.

When a transverse electric field is generated, the potential difference is usually generated at least between electrodes (e.g. the pair of comb-shaped electrodes) of the second substrate. For example, the device may be in a mode such that the higher potential difference is generated between electrodes of the second substrate than that between the electrode (e.g. the planar electrode) of the first substrate and the electrode (e.g. the slit-formed electrode) of the second substrate. The device may be in a mode such that the lower potential difference is generated between electrodes of the second substrate than that between the electrode of the first substrate and the electrode of the second substrate.

The commonly connected lower electrodes (slit-formed electrodes of the second substrate) corresponding to even-numbered lines and the commonly connected lower electrodes (slit-formed electrodes of the second substrate) corresponding to odd-numbered lines may be applied to make it possible to invert the electric potential changes thereof.

At least one of the first substrate and the second substrate preferably includes a thin film transistor element, and the thin film transistor element may be an amorphous Si TFT, a polycrystalline Si TFT, or the like, and preferably includes an oxide semiconductor. In other words, the thin film transistor element preferably includes an oxide semiconductor TFT.

The first substrate and the second substrate of the liquid crystal display panel of the present invention constitute a pair of substrates to interpose the liquid crystal layer. For example, the pair of substrates are formed such that wiring, electrodes, color filters, and the like are formed on an insulating substrate made of glass or a resin and serving as a base.

Preferably, at least one of the pair of comb-shaped electrodes is a pixel electrode and the second substrate including the pair of comb-shaped electrodes is an active matrix substrate. The liquid crystal display panel of the present invention may be of a transmission type, a reflection type, or a transflective type.

The present invention also relates to a liquid crystal display device including the liquid crystal display panel of the present invention. Preferable modes of the liquid crystal display panel in the liquid crystal display device of the present invention are the same as the aforementioned preferable modes of the liquid crystal display panel of the present invention. Examples of the liquid crystal display device include displays of personal computers, televisions, onboard devices such as automotive navigation systems, and personal digital assistants such as mobile phones. Particularly preferably, the liquid crystal display device is applied to devices used at low-temperature conditions, such as onboard devices including automotive navigation systems.

The configuration of the liquid crystal display panel and the liquid crystal display device of the present invention are not especially limited by other components as long as they essentially include such components, other configurations usually used in liquid crystal display panels and liquid crystal display devices can be arbitrarily applied.

The aforementioned modes may be employed in appropriate combination as long as the combination is not beyond the spirit of the present invention.

### Advantageous Effects of Invention

With respect to the liquid crystal display panel and the liquid crystal display device of the present invention, the first substrate includes the electrode and the dielectric layer, and the electrodes of the second substrate include the pair of comb-shaped electrodes and the slit-formed electrode to make it possible to provide a sufficiently high response speed and an excellent transmittance and to reduce flexoelectricity so as to achieve excellent display quality.

### BRIEF DESCRIPTION OF DRAWINGS

FIG. 1 is a schematic cross-sectional view showing a liquid crystal display panel according to Embodiment 1 in the presence of a transverse electric field.

FIG. 2 is a schematic cross-sectional view showing a liquid crystal display panel according to Embodiment 1 in the presence of a vertical electric field.

FIG. 3 is a schematic cross-sectional view showing a liquid crystal display panel according to Embodiment 1.

FIG. 4 is a schematic cross-sectional view showing a liquid crystal display panel according to Embodiment 1 in the presence of a transverse electric field.

FIG. 5 shows one of simulation results in the presence of a transverse electric field in a liquid crystal display panel including an overcoat layer in a counter substrate.

FIG. 6 shows one of simulation results in the presence of a transverse electric field in a liquid crystal display panel including an overcoat layer in a counter substrate.

FIG. 7 is a graph showing measurement results and simulation results of standardized luminance of, with respect to time(s) in rising, a liquid crystal display panel including an overcoat layer in a counter substrate.

FIG. 8 is a schematic cross-sectional view showing a liquid crystal display panel according to Embodiment 2 and Embodiment 3.

FIG. 9 is a schematic plan view showing a liquid crystal display panel according to Embodiment 2 and Embodiment 3.

FIG. 10 is a graph showing changes in offset voltage with respect to a slit width S₁ of an upper electrode and a lower electrode in a liquid crystal display panel according to Embodiment 2.

FIG. 11 is a graph showing changes in offset voltage with respect to a voltage of a lower electrode of a liquid crystal display panel according to Embodiment 3.

FIG. 12 is a graph showing standardized luminance of, with respect to time(s), a liquid crystal display panel in which slit widths S₁ of an upper electrode and a lower electrode are set to 1.25 μm, an overcoat layer is formed in a counter substrate, and a voltage of a lower electrode is set to 7.5 V.

FIG. 13 is a schematic cross-sectional view showing one example of a liquid crystal display panel of the present embodiment.

FIG. 14 is a schematic plan view showing an active drive element and its vicinity used in the present embodiment.

FIG. 15 is a schematic cross-sectional view showing an active drive element and its vicinity used in the present embodiment.

FIG. 16 is a schematic cross-sectional view showing a liquid crystal display panel according to Comparative Example 1.

FIG. 17 is a schematic cross-sectional view showing a liquid crystal display panel according to Comparative Example 1 in the presence of a transverse electric field.

FIG. 18 shows one of simulation results in the presence of a transverse electric field in the same liquid crystal display panel as that in FIG. 5 except for including no overcoat layer.

FIG. 19 shows one of simulation results in the presence of a transverse electric field in the same liquid crystal display panel as that in FIG. 6 except for including no overcoat layer.

FIG. 20 is a graph showing measurement results and simulation results of standardized luminance of, with respect to time(s) in rising, a liquid crystal display panel including no overcoat layer.

FIG. 21 is a graph showing standardized luminance of, with respect to time(s), a liquid crystal display panel when a lower electrode of a liquid crystal display panel in FIG. 12 is a planar electrode.

### DESCRIPTION OF EMBODIMENTS

The present invention will be mentioned in more detail referring to the drawings in the following embodiments, but is not limited to these embodiments.

The term “pixel” herein also means a picture element (subpixel) unless otherwise specified. The planar electrode may include, for example, dot-patterned ribs and/or slits as long as it is a planar electrode as defined in the technical field of the present invention. However, the planar electrode preferably substantially includes no alignment-controlling structure. Of a pair of substrates interposing the liquid crystal layer, the substrate on the display surface side is also referred to as an upper substrate, and a substrate on a side opposite to the display surface is also referred to as a lower substrate. Of the electrode disposed in the substrates, an electrode on the display surface side is also referred to as an upper electrode, and an electrode on a side opposite to the display surface is also referred to as a lower electrode. The circuit substrate (second substrate) of the present embodiment is also referred to as a TFT substrate or an array substrate because it includes a thin film transistor element (TFT). In the present embodiment, in both rising (for example, application of a transverse electric field) and falling (for example, application of vertical electric field), the TFT is turned on to apply a voltage to at least one electrode (pixel electrode) of the pair of comb-shaped electrodes.

In each embodiment, the components or parts having the same function are given the same reference number. In the drawings, unless otherwise specified, the symbol (i) indicates an electric potential of one of the comb-shaped electrodes on the upper layer of the lower substrate; the symbol (ii) indicates an electric potential of the other of the comb-shaped electrodes on the upper layer of the lower substrate; the symbol (iii) indicates an electric potential of the lower electrode;

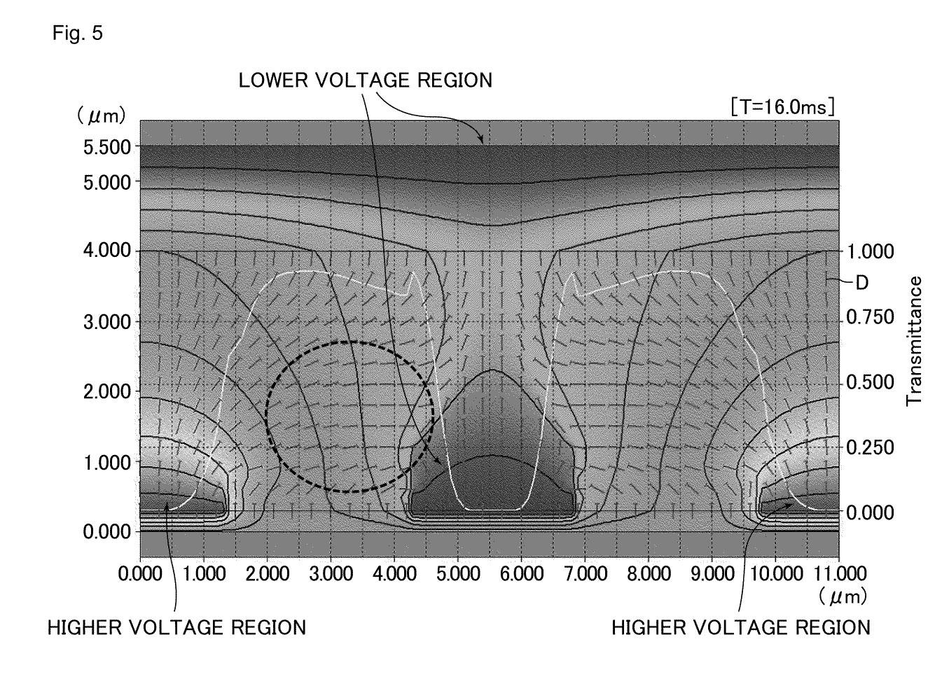

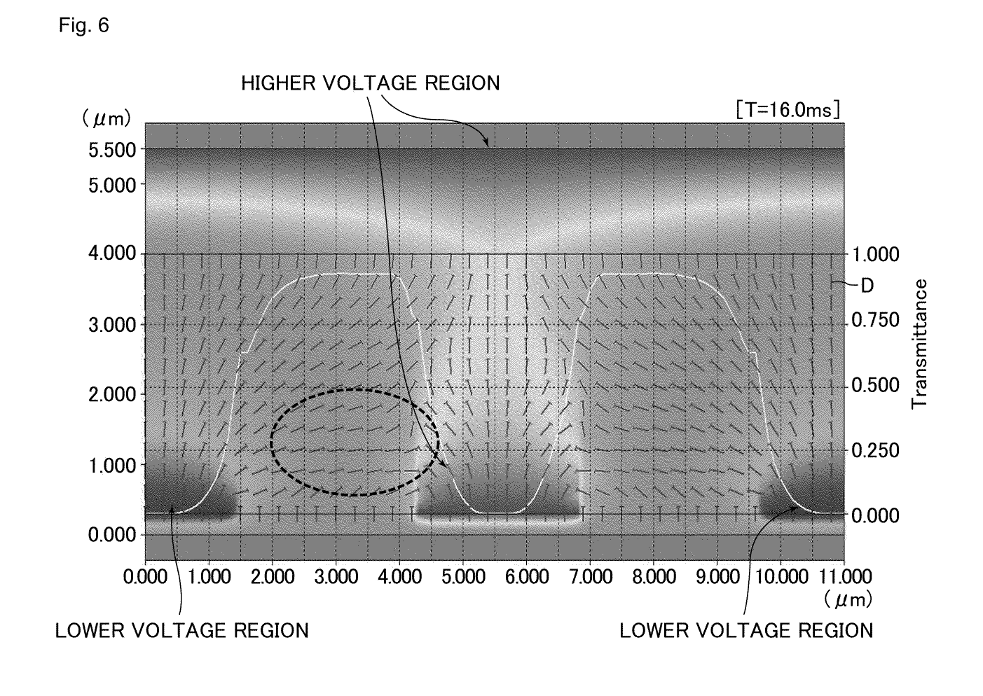

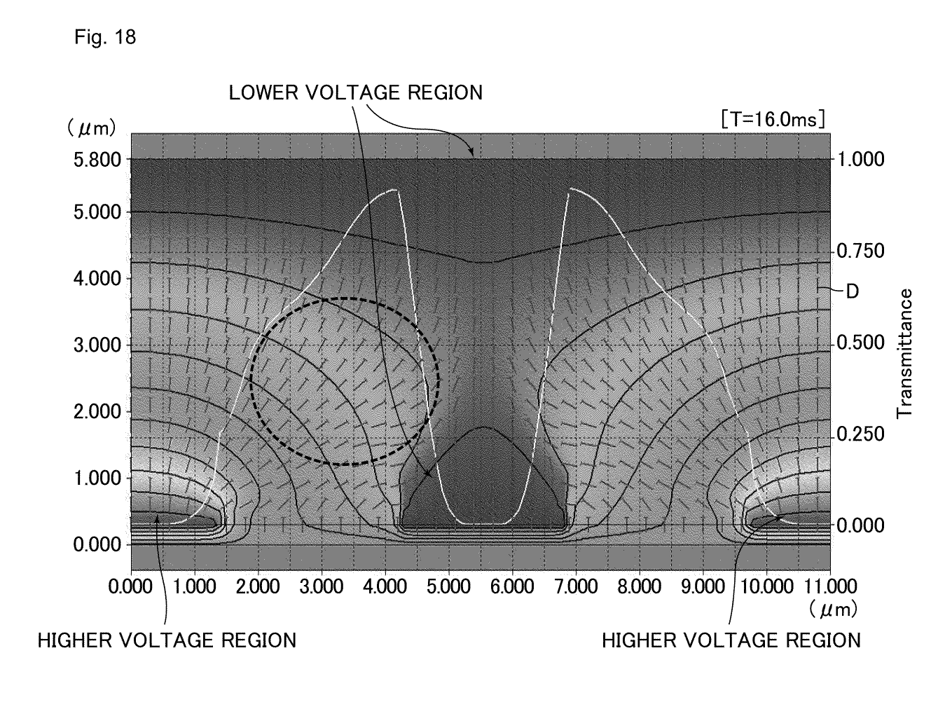

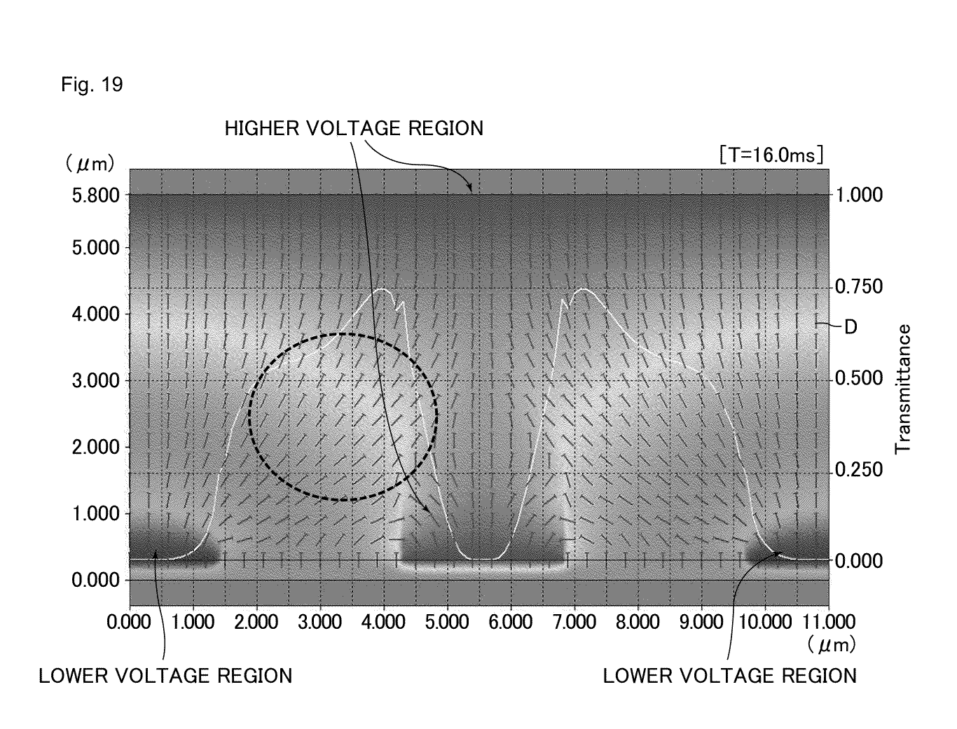

and the symbol (iv) indicates an electric potential of the planar electrode in the upper substrate. In FIG. 5, FIG. 6, FIG. 18, and FIG. 19, a transmittance distribution is indicated by a white line. In particular, FIG. 5 and FIG. 18 each show a solid line indicating an equipotential line. In each embodiment, the components or parts having the same function are given the same reference number.

In the embodiments to be mentioned later, among the pair of comb-shaped electrodes and the slit-formed electrode disposed in the lower substrate, the pair of comb-shaped electrodes are used as an upper electrode and the slit-formed electrode is used as a lower electrode. This is one preferable mode to provide the effects of the present invention. Although not shown in drawings (FIG. 5, FIG. 6, FIG. 18, and FIG. 19) showing simulation results, the polarities of not only the upper electrode but also the lower electrode are inverted.

### Embodiment 1

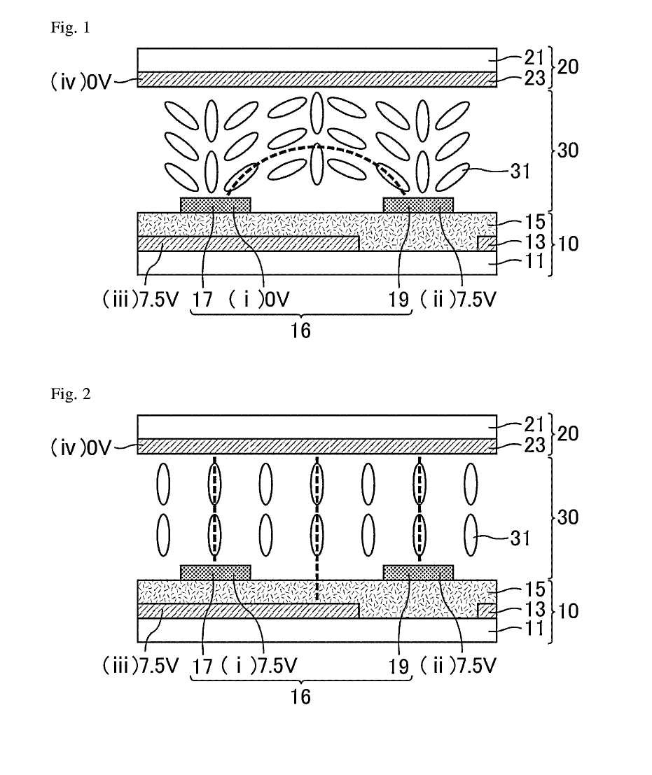

FIG. 1 is a schematic cross-sectional view showing a liquid crystal display panel according to Embodiment 1 in the presence of a transverse electric field. FIG. 2 is a schematic cross-sectional view showing a liquid crystal display panel according to Embodiment 1 in the presence of a vertical electric field.

A liquid crystal display device including a vertical-alignment three-layered electrode structure (an upper electrode in a lower substrate is a comb-shaped electrode) using a positive-type liquid crystal is characterized in that liquid crystal molecules are rotated in both rising and falling by a transverse electric field generated by the potential difference between the comb-shaped electrodes in rising and by a vertical electric field generated by the potential difference between the substrates in falling to provide a high response speed and also a high transmittance with a transverse electric field in the comb driving.

In FIG. 1 and FIG. 2, an overcoat layer is not shown. However, in the present embodiment, as will be described later, the overcoat layer is formed and a slit is formed in the lower electrode to make it possible to suppress the difference (difference between alignments based on the difference between the polarities of applied voltages in drive electrodes) of alignments between polarities that usually pose a problem and to make it possible to reduce flexoelectricity.

In Embodiment 1, a lower electrode 13 is disposed just below a comb-shaped electrode 17. In each of FIG. 1 and FIG. 2, the dot line indicates the direction of an electric field generated. The liquid crystal display panel according to Embodiment 1 includes a vertical-alignment three-layered electrode structure (upper electrodes of the lower substrate, which serves as the second layer, are a pair of comb-shaped electrodes 16) using liquid crystal molecules 31 which are positive-type liquid crystal. In Embodiment 1, the lower electrode 13 is preferably driven independently of the comb-shaped electrode 17 and the lower electrode 13 and a comb-shaped electrode 19 are preferably commonly driven so that the electrodes are commonly driven to reduce the number of TFTs from the viewpoint that the liquid crystal display panel can be easily manufactured and the viewpoint that an aperture ratio can be sufficiently improved. However, the lower electrode 13 and the comb-shaped electrode 19 may also be driven independently of each other. In rising, as shown in FIG. 1, a transverse electric field generated by the potential difference of 7.5 V between the pair of comb-shaped electrodes 16 (for example, between the comb-shaped electrode 17 having an electric potential of 0 V and the comb-shaped electrode 19 having an electric potential of 7.5 V) rotates the liquid crystal molecules. At this time, the potential difference is also generated between the substrates (between the lower electrode 13 having an electric potential of 7.5 V and a counter electrode 23 having an electric potential of 0 V). As described above, the voltage of the lower electrode is set to be higher than that of the counter electrode to make it possible to reduce flexoelectricity.

In falling, as shown in FIG. 2, a vertical electric field generated by the potential difference of 7.5 V between the substrates (for example, between each of the lower electrode 13, the comb-shaped electrode 17, and the comb-shaped electrode 19 having an electric potential of 7.5 V and the counter electrode 23 having an electric potential of 0 V) rotates the liquid crystal molecules. In this case, substantially no potential difference is generated between the pair of comb-shaped electrodes 16 (for example, between the comb-shaped electrode 17 having an electric potential of 7.5 V and the comb-shaped electrode 19 having an electric potential of 7.5 V)

In both the rising and the falling, an electric field rotates the liquid crystal molecules to provide a high response speed. In other words, a wide-range transverse electric field between the pair of comb-shaped electrodes 16 leads to the ON state to give a high transmittance in the rising, whereas the vertical electric field between the substrates leads to the ON state to give a high response speed in the falling. Further, the transverse electric field by comb driving also provides a high transmittance. Embodiment 1 and the following embodiments use a positive-type liquid crystal as the liquid crystal. However, a negative-type liquid crystal may be used in place of a positive-type liquid crystal. In the case of a negative-type liquid crystal, the potential difference between the pair of substrates aligns the liquid crystal molecules in the horizontal direction and the potential difference between the pair of comb-shaped electrodes aligns the liquid crystal molecules in the horizontal direction. In this manner, an excellent transmittance is obtained, the liquid crystal molecules are rotated by the electric fields in both rising and falling to make it possible to provide a high response speed. Also in use of a negative-type liquid crystal, flexoelectricity is reduced to make it possible to improve display quality.

As described above, formation of a slit in the lower electrode 13 makes it possible to provide a higher response speed and a higher transmittance. The lower electrode 13 is electrically connected as a whole such that it surrounds the slit.

As shown in FIG. 1 and FIG. 2, the liquid crystal display panel according to Embodiment 1 includes an array substrate 10, a liquid crystal layer 30, and a counter substrate 20 (color filter substrate) stacked in the order set forth from the back side to the viewing side of the liquid crystal display panel. As shown in FIG. 2, the liquid crystal display panel of Embodiment 1 vertically aligns the liquid crystal molecules at lower than the threshold voltage. As shown in FIG. 1, an electric field generated between the comb-shaped electrodes 17 and 19 (the pair of comb-shaped electrodes 16) serving as upper electrodes disposed on a glass substrate 11 (second substrate) tilts the liquid crystal molecules in the horizontal direction between the comb-shaped electrodes when the voltage difference between the comb-shaped electrodes is not lower than the threshold voltage, thereby controlling the amount of light transmitted. The slit-formed lower electrode 13 is disposed such that it interposes an insulating layer 15 with the comb-shaped electrodes 17 and 19 (the pair of comb-shaped electrodes 16) serving as upper electrodes. The insulating layer 15 may be formed from an oxide film (e.g. SiO₂), a nitride film (e.g. SiN), or an acrylic resin, for example, and these materials may be used in combination.

Although not shown in FIG. 1 and FIG. 2, a polarizing plate is disposed on each substrate at the side opposite to the liquid crystal layer. The polarizing plate may be a circularly polarizing plate or may be a linearly polarizing plate. An alignment film is disposed on the liquid crystal layer side of each substrate. The alignment film may be an organic alignment film or may be an inorganic alignment film as long as they align the liquid crystal molecules vertically to the film surface.

A voltage supplied from a source bus line is applied to the comb-shaped electrode 19, which drives the liquid crystal material, through a thin film transistor element (TFT) at the timing when a pixel is selected by a gate bus line. The comb-shaped electrode 17 and the comb-shaped electrode 19 are formed on the same layer in the present embodiment and are preferably in a mode where they are formed on the same layer. Still, the comb-shaped electrodes may be formed on different layers as long as the voltage difference is generated between the comb-shaped electrodes to apply a transverse electric field and provides one effect of the present invention, that is, the effect of improving the transmittance. The comb-shaped electrode 19 is connected to a drain electrode that extends from the TFT through a contact hole. The slit-formed lower electrodes 13 corresponding to the even-numbered gate bus lines may be commonly connected and the slit-formed lower electrodes 13 corresponding to the odd-numbered gate bus lines may be commonly connected. The counter electrode 23 has a planar shape and is commonly connected for all pixels.

The electrode width L of each comb-shaped electrode is preferably 2 μm or greater from the viewpoint of preventing problems in device production such as leakage and disconnection. The electrode gap S between the comb-shaped electrodes is preferably 2 μm or greater, for example. Each of the upper limits of the electrode width and the electrode gap is preferably 7 μm, for example.

The ratio (L/S) between the electrode gap S and the electrode width L is preferably 0.4 to 3, for example. The lower limit of the ratio is more preferably 0.5, whereas the upper limit thereof is more preferably 1.5.

The cell thickness d_{1c} may be 2 μm to 7 μm, and preferably falls within this range. The cell thickness d_{1c} (thickness of the liquid crystal layer) herein is preferably calculated by averaging all the thicknesses of the liquid crystal layers in the liquid crystal display panel. The liquid crystal layer in the present embodiment is configured by nematic liquid crystal.

The liquid crystal display device including the liquid crystal display panel of Embodiment 1 may appropriately include the components that usual liquid crystal display devices include (e.g. light source). The same shall apply to the following Embodiments 2 and 3.

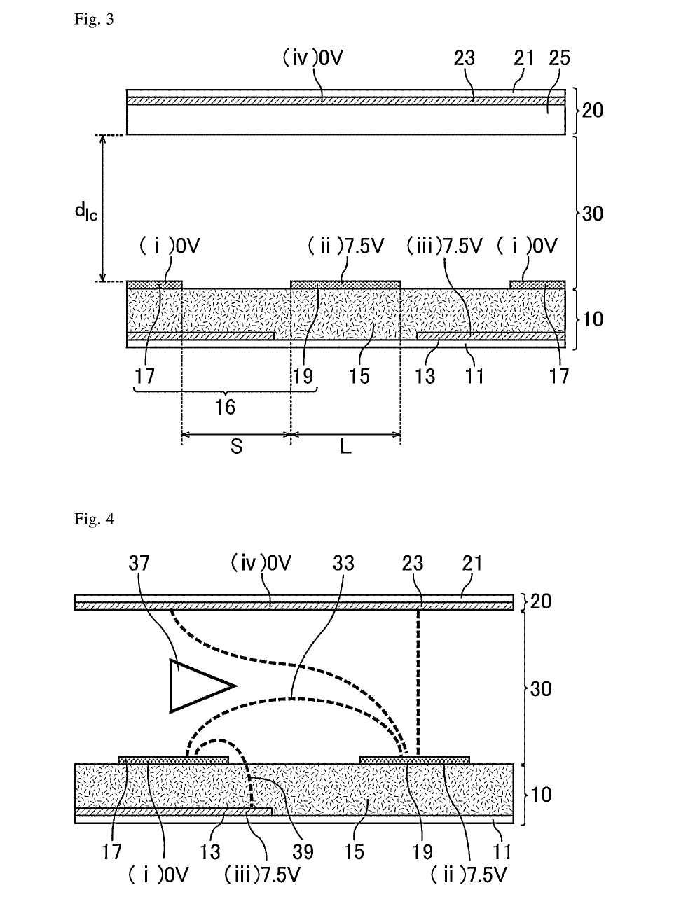

FIG. 3 is a schematic cross-sectional view showing a liquid crystal display panel according to Embodiment 1. FIG. 4 is a schematic cross-sectional view showing a liquid crystal display panel according to Embodiment 1 in the presence of a transverse electric field.

In such a mode that uses a transverse electric field by comb-shaped electrodes as in on-on driving, usually, the difference of alignments between positive and negative polarities by flexoelectricity appears to generate the difference between transmittances. As in the present embodiment, in a three-layered electrode structure, the lower electrode in the lower substrate includes a slit structure and is provided with an overcoat layer 25. When a voltage higher than that of the counter electrode is applied to the lower electrode, in a mode in which a transverse electric field 33 by the comb-shaped electrodes is used, a region 37 in which the liquid crystal molecules are spray-aligned can be suppressed to be small, flexoelectricity can be reduced, and a flicker can be suppressed to make it possible to provide excellent display quality. The same operational effects are obtained in the following embodiments.

On the other hand, in a method in which the lower electrode is a planar electrode including no slit, since a line of electric force is obliquely strongly pulled downward in an on state, a region 237 in which liquid crystal molecules are spray-aligned appears in a wide range (FIG. 17 (will be described later)). When the lower-layer voltage is made high by the structure according to Embodiment 1 as described above, a line of electric force 39 on (i), a side on which the voltage of the comb-shaped electrode is low (comb-shaped electrode 17 overlapping the lower electrode), can be pulled just downward. (ii), a side on which the voltage of the comb-shaped electrode is high (the comb-shaped electrode 19 that does not overlap the lower electrode) and the voltage (iii) of the lower electrode are preferably set to almost equal potentials. In this manner, an excessive line of electric force does not flow therebetween, and, as described above, spray alignment can be minimized to make it possible to reduce flexoelectricity. More specifically, when the line of electric force is pulled downward, electric field distortion (portion where the line of electric force 39 is pulled) becomes small, and the transverse electric field 33 can be improved. In other words, in the liquid crystal display panel in which the lower electrode includes a slit and the overcoat layer is formed on the counter substrate (counter electrode) side, for example, when the voltage of the lower electrode is made high, a line of electric force obliquely flowing between the comb-shaped electrode on the low-potential side and the lower electrode can be pulled almost downward. The voltage of the overcoat layer of the upper substrate and the voltage of the electrode in the lower substrate are balanced to minimize spray alignment, and flexoelectricity can be minimized.

When the positive and negative polarities are electrically matched with each other, more specifically, when the value of a positive applied voltage and the value of a negative applied voltage are equal to each other as usual, flexoelectricity generates the difference between transmittances. Thus, an optical displacement occurs, and a flicker occurs. In order to eliminate the flicker, an electric offset may be given to each of the positive and negative polarities to make the luminance equal to each other. However, in this case, since DC image sticking occurs, the offset voltages must be minimized. It is said that the suppression of flexoelectricity substantially means the decrease in offset voltage.

(Improvement of Flexoelectricity by Overcoat Layer [Effect Obtained when Lower Electrode is Planar Electrode])

FIG. 5 and FIG. 6 each show one of simulation results in the presence of a transverse electric field in a liquid crystal display panel including an overcoat layer in a counter substrate.

### (Alignment Distribution in Simulation [Static State])

In FIG. 5, FIG. 6, FIG. 18, and FIG. 19 (FIG. 18 and FIG. 19 will be described later), alignment distributions in the presence/absence of an overcoat layer under the condition in which the transmittances are almost equal to each other are compared with each other [lower electrode is ±4 V]. FIG. 5 and FIG. 6 show the case in which the overcoat layer is present. FIG. 5 shows the alignment distribution having a positive polarity (a positive potential is applied to electrodes located at both the right and left ends and a negative potential is applied to an electrode located at the center), and FIG. 6 shows the alignment distribution having a negative polarity (a negative potential is applied to electrodes located at both the right and left ends and a positive potential is applied to an electrode located at the center). FIG. 18 and FIG. 19 (will be described later) show the case in which an overcoat layer is absent. In FIG. 5 and FIG. 6, horizontal liquid crystal increases especially in a portion surrounded by a dotted line, an oblique spray alignment component that is observed in FIG. 18 and FIG. 19 (will be described later) can be reduced.

(Explanation of Alignment Distribution Map [FIG. 5, FIG. 6, FIG. 18, and FIG. 19 (FIG. 18 and FIG. 19 will be Described Later)])

The alignment simulation shows that, in the structure in which the lower electrode is a planar electrode including no slit, flexoelectricity can be reduced in the presence of an overcoat layer much more considerably than in the absence of an overcoat layer. These are drawings showing one of the principles of the present invention. More specifically, the liquid crystal display panel including the overcoat layer in the counter electrode (first substrate) and the liquid crystal display panel including no overcoat layer have spray alignment regions largely different from each other. Since the overcoat layer is formed to decrease the spray alignment region and to increase a horizontal alignment region, an influence by flexoelectricity does not easily appear. As a result, the transmittance difference caused by the difference between positive and negative voltages applied to the electrodes decreases, and an offset voltage can be reduced.

The simulation conditions and the measurement conditions are as described below.

(Counter Substrate with Overcoat Layer)

Layer thickness d_{oc} of overcoat layer: 1.5 μm (Dielectric constant ε_{oc}=3.8 of overcoat layer)

Cell thickness of liquid crystal: 3.7 μm

Insulating layer thickness d_{PAS} (passivation film) of second substrate: 0.3 μm (ε_{PAS}=6.9)

(Counter Substrate with No Overcoat Layer)

Cell thickness of liquid crystal: 5.5 μm

Insulating layer thickness d_{PAS} (passivation film) of second substrate: 0.3 μm (ε_{PAS}=6.9)

### (Other Common Conditions)

Voltages (i) and (ii) of upper comb-shaped electrode: 0V-±7.5V

Voltage (iii) of lower electrode: ±4V

Ratio (L/S) of electrode gap S and electrode width L in upper comb-shaped electrode: 2.5 μm/3.0 μm

Lower electrode: planar electrode including no slit Flexo coefficients e1=28, e3=−2

The flexo coefficients el and e3 each mean a physical property value of applied liquid crystal.

In the present invention, the lower electrode is a slit-formed electrode. However, as in the simulation result, when the lower electrode is a slit-formed electrode, an overcoat layer is formed in the counter substrate to make it possible to reduce flexoelectricity.

### (Measurement Result and Simulation Result)

### Rising Response (Influence by Flexoelectricity)

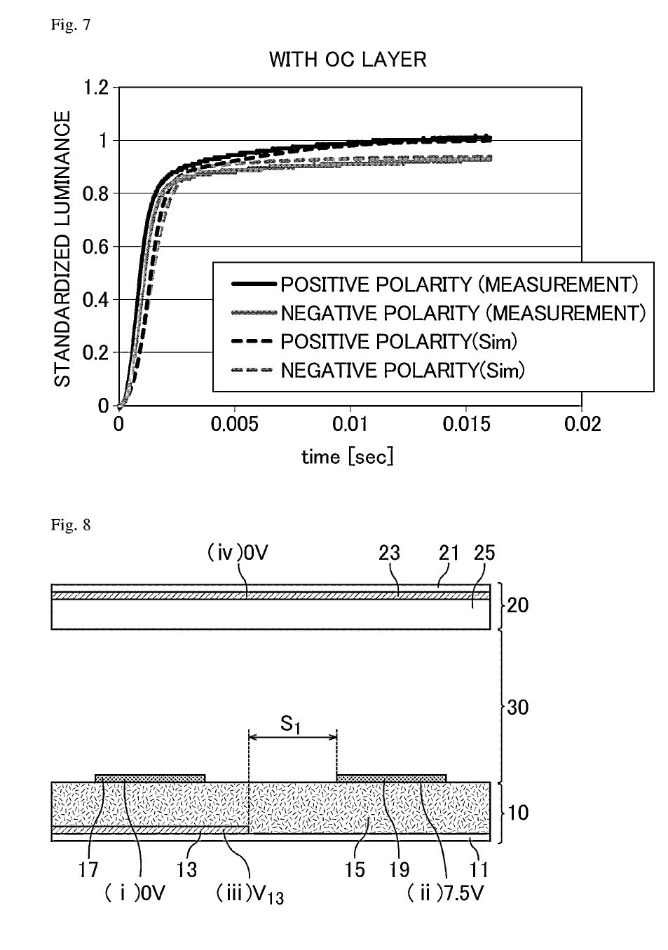

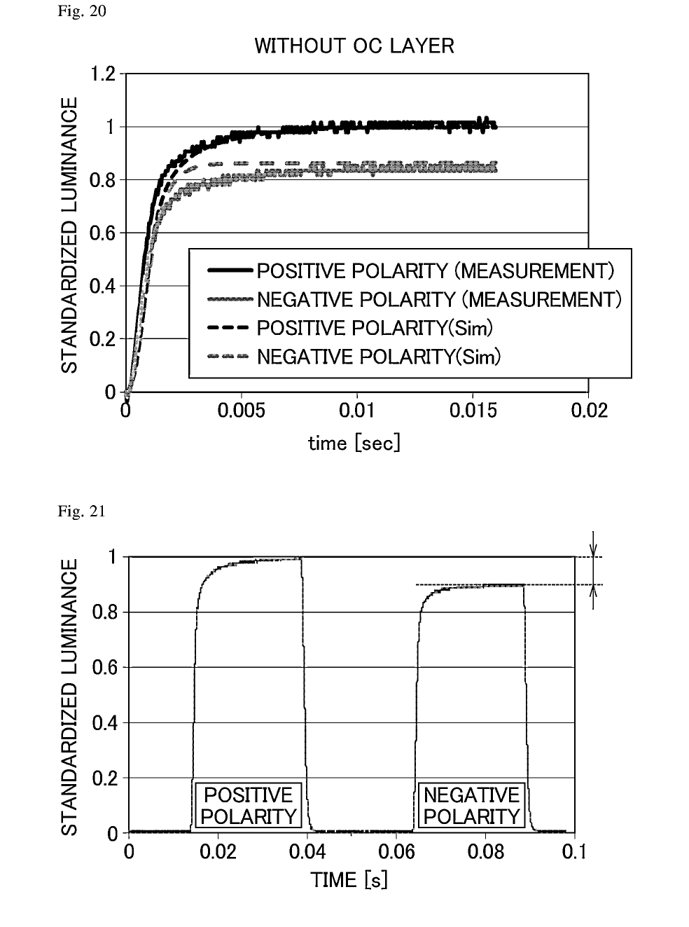

FIG. 7 is a graph showing measurement results and simulation results of standardized luminance of, with respect to time(s) in rising, a liquid crystal display panel including an overcoat layer in a counter substrate. More specifically, FIG. 7 shows measurement results and simulation results obtained when, under the simulation conditions described above, a state rises from an alignment state in which no voltage is applied to a state (corresponding to white 255 gradations) in which the upper layer is applied with 0 V to ±7.5 V/the lower layer is applied with ±4 V. FIG. 20 is a graph showing measurement results and simulation results of standardized luminance of, with respect to time(s) in rising, a liquid crystal display panel including no overcoat layer. In FIG. 7, the word “measurement” means a measurement result, and the word “Sim” means a simulation result. The same shall apply to the FIG. 20 to be mentioned later.

When FIG. 7 is compared with FIG. 20 to be described later, it can be confirmed that the transmittance difference between positive and negative polarities caused by flexoelectricity is smaller in the presence of an overcoat layer in the counter substrate than in the absence of an overcoat layer in the counter substrate.

### (Improvement of Flexoelectricity by Overcoat Layer+Slit of Lower Electrode [Optimization of Voltage of Lower Electrode and Slit of Lower Electrode])

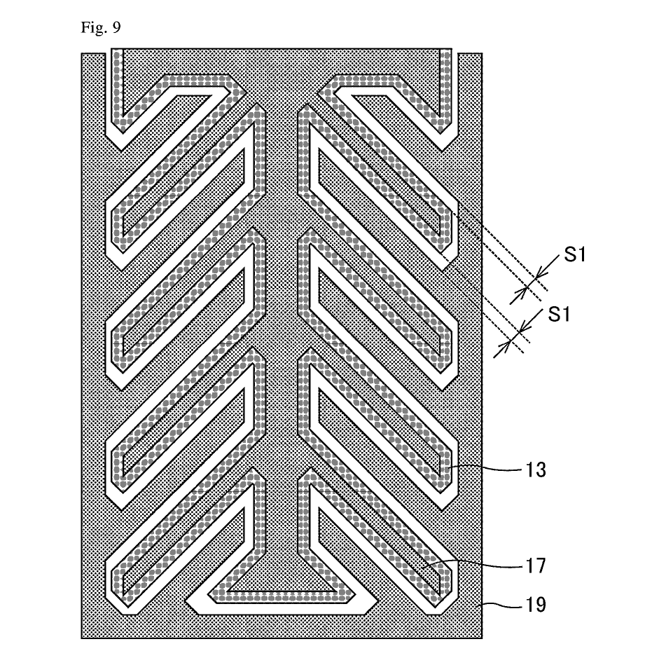

FIG. 8 is a schematic cross-sectional view showing a liquid crystal display panel according to Embodiment 2 and Embodiment 3. FIG. 9 is a schematic plan view showing a liquid crystal display panel according to Embodiment 2 and Embodiment 3.

In FIG. 8 and FIG. 9, reference symbol S₁ indicates a slit width of each of the upper electrode and the lower electrode. FIG. 9 shows an example of an electrode structure in a plan view of the main surfaces of the substrates when the edge of the slit-formed lower electrode 13 is disposed along a line passing through the center of a gap (space) between the comb-shaped electrode 17 and the comb-shaped electrode 19 on the upper layer.

Embodiment 2 examined optimization of the slit widths of the upper electrode and the lower electrode. Embodiment 3 examined optimization of a voltage applied to the lower electrode. These modes are preferably combined to each other.

Measurement conditions in Embodiment 2 and Embodiment 3 are as follows.

Ratio (L/S) of electrode gap S and electrode width L: 2.5 μm/3 μm

Cell thickness d_{1c} of liquid crystal: 3.5 μm

Voltage difference between comb-shaped electrodes to apply transverse electric field: 7.5V

### Embodiment 2

(Changes in Offset Voltage with Respect to Slit Width S₁ of Upper Electrode and Lower Electrode)

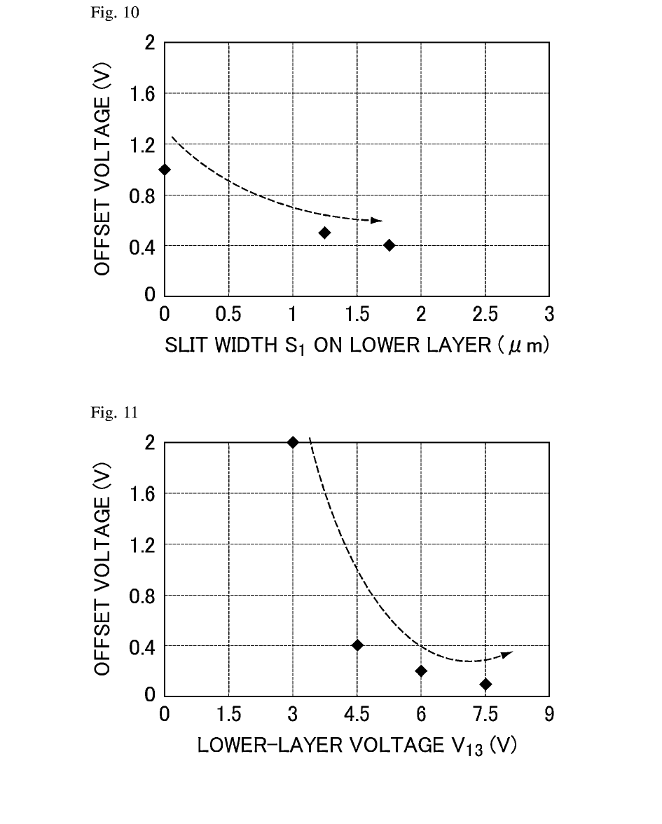

FIG. 10 is a graph showing changes in offset voltage with respect to a slit width S₁ of an upper electrode and a lower electrode in a liquid crystal display panel according to Embodiment 2. When the slit width S₁ is increased, the offset voltage decreases. For example, the slit width S₁ is preferably 30% or more of the slit width of the upper comb-shaped electrode. The upper limit may be 100% or less.

The slit width S₁ of the upper electrode and the lower electrode herein, as shown in FIG. 8, means a horizontal distance between the edge of the lower electrode and the edge of the upper electrode. In other words, as shown in FIG. 9, in a plan view of the main surfaces of the substrates, the slit width S₁ means the width of a linear portion that does not overlap the upper electrode and the lower electrode. A voltage V₁₃ of the lower electrode is set to 4.5 V.

The other configurations in Embodiment 2 are the same as those in the aforementioned Embodiment 1.

### Embodiment 3

### (Changes in Voltage V₁₃ of Lower Electrode)

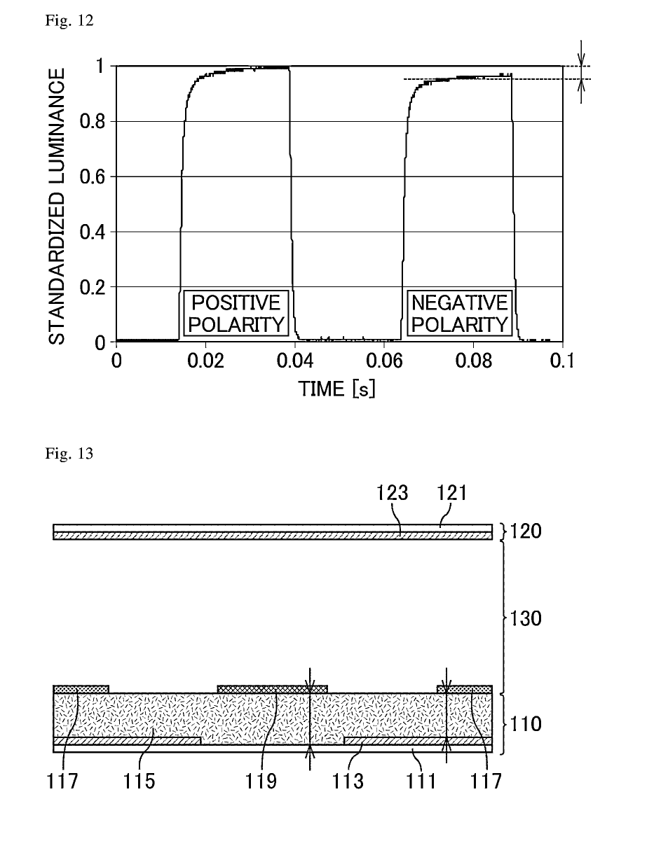

FIG. 11 is a graph showing changes in offset voltage with respect to a voltage (iii) (to be referred to as V₁₃ hereinafter) of a lower electrode of a liquid crystal display panel according to Embodiment 3.

When the voltage V₁₃ applied to the lower electrode is increased from 3 V to 7.5 V, the offset voltage decreases. The voltage V₁₃ applied to the lower electrode is 7.5 V (potential equal to that of one side of the upper electrode) and has an effect of considerably decreasing the offset voltage. However, for example, as long as the voltage V₁₃ applied to the lower electrode is preferably higher than a voltage (iv) of the counter electrode by 4.5 V or higher, the offset voltage can be sufficiently decreased, which is preferable. A voltage (ii) of the comb-shaped electrode that does not overlap the slit-formed electrode is set to be almost equal to the voltage V₁₃ of the slit-formed electrode, a voltage (i) of the comb-shaped electrode that overlaps the slit-formed electrode is preferably set to be lower than the voltage (ii) of the comb-shaped electrode that does not overlap the slit-formed electrode and the voltage V₁₃ of the slit-formed electrode by, e.g., 4.5 V or more. The slit width S₁ of the upper electrode and the lower electrode is set to 1.25 μm.

The other configurations in Embodiment 3 are the same as those in the aforementioned Embodiment 1.

(Confirmation Result of Reduction in Offset Voltage Obtained when Slit Width S₁ of Upper Electrode and Lower Electrode is set to 1.25 μm, Overcoat Layer is Formed in Counter Substrate, and Voltage of Lower Electrode is set to 7.5 V)

FIG. 12 is a graph showing standardized luminance of, with respect to time(s), a liquid crystal display panel in which slit widths S₁ of an upper electrode and a lower electrode are set to 1.25 μm, an overcoat layer is formed in a counter substrate, and a voltage of a lower electrode is set to 7.5 V. More specifically, this mode is obtained by combining the preferable modes of Embodiment 2 and Embodiment 3 to each other. The other modes in the present embodiment are the same as those in the aforementioned Embodiment 1. In this case, an offset voltage required to uniform the brightness of positive and negative polarities can be set to a low voltage, i.e., 0.2 V.

The present invention is preferably applied to a liquid crystal display panel including a three-layered electrode structure. However, as long as a structure having a slit formed in a lower layer is employed to reduce flexoelectricity, the present invention can be applied to not only a liquid crystal display panel in an on-on mode but also a liquid crystal display panel in a TBA mode and a liquid crystal display panel in an FFS mode.

When the overcoat layer is formed in the counter substrate, the counter electrode, the upper electrode, and the lower electrode can be balanced even though a small liquid crystal thickness (cell thickness) is used. For this reason, a high transmittance and reduction in flexoelectricity can be expected. Since the voltage of the lower electrode can be usually increased under conditions unique to an on-on mode, an effect of reducing flexoelectricity obtained by setting the voltage of the lower electrode (setting the voltage of the lower electrode to a value largely different from the voltage of the counter electrode) becomes conspicuous especially in the on-on mode.

In the embodiments of the present invention, an oxide semiconductor TFT (e.g. IGZO) is preferably used. The following will describe this oxide semiconductor TFT in detail.

At least one of the upper and lower substrates usually includes a thin film transistor element. The thin film transistor element preferably includes an oxide semiconductor. In other words, in the thin film transistor element, an active layer of an active drive element (TFT) is preferably formed using an oxide semiconductor film such as zinc oxide instead of a silicon semiconductor film. Such a TFT is referred to as an “oxide semiconductor TFT”. The oxide semiconductor characteristically shows a higher carrier mobility and less unevenness in its properties than amorphous silicon. Thus, the oxide semiconductor TFT is driven faster than an amorphous silicon TFT, has a high driving frequency, and is suitably used for driving of higher-definition next-generation display devices. In addition, the oxide semiconductor film is formed by an easier process than a polycrystalline silicon film. Thus, it is advantageously applied to devices requiring a large area.

The following characteristics markedly appear in the case of applying the liquid crystal driving method of the present embodiments especially to FSDs (field sequential display devices).

(1) The pixel capacitance is higher than that of a usual VA (vertical alignment) mode (FIG. 13 is a schematic cross-sectional view showing one example of a liquid crystal display panel of the present embodiment; in FIG. 13, a large capacitance is generated between the upper electrode and the lower electrode at the portion indicated by an arrow and the pixel capacitance is higher than in the liquid crystal display device of a usual vertical alignment (VA) mode). (2) One pixel of a FSD type is equivalent to three pixels (RGB), and thus the capacitance of one pixel is trebled. (3) The gate ON time is very short because 240 Hz or higher driving is required.

Advantages of applying the oxide semiconductor TFT (e.g. IGZO) are as follows.

Based on the characteristics (1) and (2), a 52-inch device has a pixel capacitance of about 20 times as high as a 52-inch UV2A 240-Hz drive device.

Thus, a transistor produced using conventional a-Si is as great as about 20 times or more, disadvantageously resulting in an insufficient aperture ratio.

The mobility of IGZO is about 10 times that of a-Si, and thus the size of the transistor is about 1/10.

Although the liquid crystal display device using color filters (RGB) includes three transistors, the FSD type device includes only one transistor. Thus, the liquid crystal display device can be manufactured to have a size almost equal to or smaller than that using a-Si.

When the transistor decreases in size as described above, the capacitance of Cgd also decreases. Accordingly, a load on the source bus line also decreases.

### Specific Examples

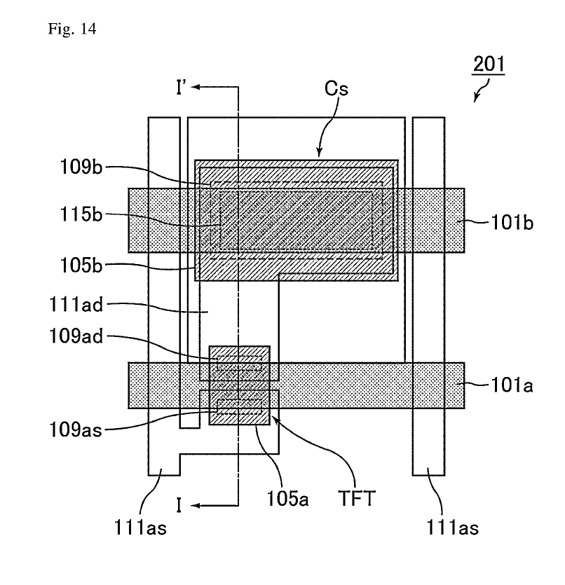

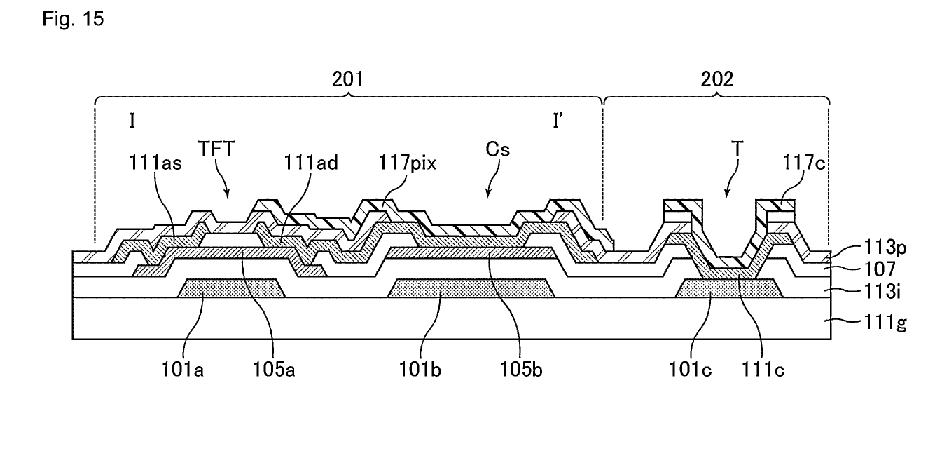

FIG. 14 and FIG. 15 each show a structure (example) of the oxide semiconductor TFT. FIG. 14 is a schematic plan view showing an active drive element and its vicinity used in the present embodiment. FIG. 15 is a schematic cross-sectional view showing an active drive element and its vicinity used in the present embodiment. The symbol T indicates a gate and source terminal. The symbol Cs indicates an auxiliary capacitance.

The following will describe one example (the corresponding portion) of a production process of the oxide semiconductor TFT.

Active layers (oxide semiconductor layers 105a and 105b) of an active drive element (TFT) using an oxide semiconductor film will be formed as follows.

At first, for example, an In—Ga—Zn—O semiconductor (IGZO) film with a thickness of 30 nm or greater but 300 nm or smaller is formed on an insulating film 113i by a sputtering method. Then, a resist mask is formed by photolithography so as to cover predetermined regions of the IGZO film. Next, portions of the IGZO film other than the regions covered by the resist mask are removed by wet etching. Thereafter, the resist mask is peeled off. This provides the island-shaped oxide semiconductor layers 105a and 105b. The oxide semiconductor layers 105a and 105b may be formed using other oxide semiconductor films instead of the IGZO film.

Next, an insulating film 107 is deposited on the whole surface of a substrate 111g and then the insulating film 107 is patterned.

Specifically, at first, an SiO₂ film (thickness: about 150 nm, for example) as the insulating film 107 is formed on the insulating film 113i and the oxide semiconductor layers 105a and 105b by a CVD method.

The insulating film 107 preferably includes an oxide film such as SiOy.

Use of the oxide film can recover oxygen deficiency on the oxide semiconductor layers 105a and 105b by the oxygen in the oxide film, and thus it more effectively suppresses oxygen deficiency on the oxide semiconductor layers 105a and 105b. Here, a single layer consists of an SiO₂ film is used as the insulating film 107. Still, the insulating film 107 may include a stacked structure of an SiO₂ film as a lower layer and an SiNx film as an upper layer.

The thickness of the insulating film 107 (in the case of a stacked structure, the sum of the thicknesses of the layers) is preferably 50 nm or greater but 200 nm or smaller. The insulating film with a thickness of 50 nm or greater more securely protects the surfaces of the oxide semiconductor layers 105a and 105b in the step of patterning the source and drain electrodes. If the thickness of the insulating film exceeds 200 nm, the source electrodes and the drain electrodes may have a higher step, so that disconnection may occur.

The oxide semiconductor layers 105a and 105b of the present embodiment are preferably layers formed from, for example, a Zn—O semiconductor (ZnO), an In—Ga—Zn—O semiconductor (IGZO), an In—Zn—O semiconductor (IZO), a Zn—Ti—O semiconductor (ZTO), or the like. The In—Ga—Zn—O semiconductor (IGZO) is especially preferably used.

The present mode provides certain effects in combination with the above oxide semiconductor TFT. However, the present mode can also be driven by using a known TFT element such as an amorphous Si TFT or a polycrystalline Si TFT.

### Comparative Example 1

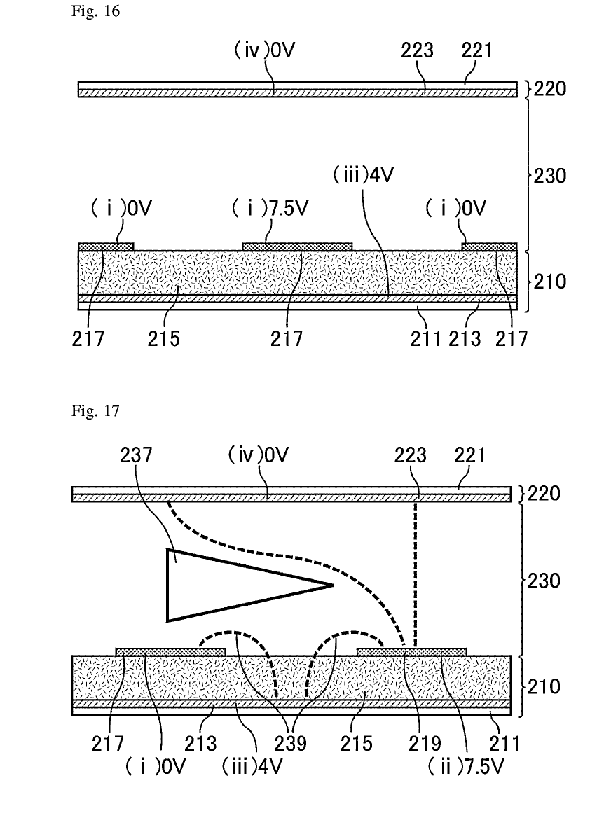

FIG. 16 is a schematic cross-sectional view showing a liquid crystal display panel according to Comparative Example 1. FIG. 17 is a schematic cross-sectional view showing a liquid crystal display panel according to Comparative Example 1 in the presence of a transverse electric field.

As described above, in the method in which a lower electrode 213 is a planar electrode including no slit as in Comparative Example 1, a line of electric force 239 is strongly obliquely pulled downward in an on-time to cause a region 237 in which liquid crystal molecules are spray-aligned to appear in a large area, and flexoelectricity cannot be sufficiently reduced. Thus, excellent display quality cannot be obtained by suppressing a flicker.

FIG. 18 shows one of simulation results in the presence of a transverse electric field in the same liquid crystal display panel as that in FIG. 5 except for including no overcoat layer. FIG. 19 shows one of simulation results in the presence of a transverse electric field in the same liquid crystal display panel as that in FIG. 6 except for including no overcoat layer. FIG. 18 and FIG. 19 show the case in which the overcoat layer is absent, as described above. FIG. 18 shows the alignment distribution having a positive polarity (a positive potential is applied to electrodes located at both the right and left ends in FIG. 18), and FIG. 19 shows the alignment distribution having a negative polarity (a negative potential is applied to electrodes located at both the right and left ends in FIG. 19). In FIG. 18 and FIG. 19, especially in a portion surrounded by a dotted line, the alignment tends to be like spray alignment, and oblique spray alignment components increase. The liquid crystal display panel cannot sufficiently reduce spray polarization, and has a high offset voltage.

FIG. 20 is a graph showing measurement results and simulation results of standardized luminance of, with respect to time(s) in rising, a liquid crystal display panel including no overcoat layer.

The transmittance difference between the positive and negative polarities caused by flexoelectricity is larger than that in the case in FIG. 7 described above.

FIG. 21 is a graph showing standardized luminance of, with respect to time(s), a liquid crystal display panel when a lower electrode of a liquid crystal display panel in FIG. 12 is a planar electrode. FIG. 21 is a result of the liquid crystal display panel under the same conditions as those in FIG. 12 except that the lower electrode includes no slit, and the liquid crystal display panel includes an overcoat layer.

When the lower electrode is a planar electrode including no slit, the influence of flexoelectricity is great, and an offset required to uniform the brightnesses of the positive and negative polarities becomes 1 V.

In a mode obtained by combining Embodiment 2 and Embodiment 3 described above, the slit size and the voltage of the lower electrode are changed to make it possible to reduce the offset voltage to 0.2 V.

The liquid crystal display panel of the present embodiment is easy to produce and is capable of providing a high transmittance. In a mode in which a response speed that enables field sequential driving can be provided, flexoelectricity feared as a cause of a flicker can be suppressed.

The liquid crystal display panels of Embodiments 1 to 3 are easy to produce and are capable of providing a high response speed and a high transmittance. Further, they provide a response speed which enables field sequential driving. With respect to the TFT substrate and the counter substrate, the electrode structure and others in the liquid crystal display panel and the liquid crystal display device of the present invention can be confirmed by microscopic observation with, for example, an SEM (scanning electron microscope).

The liquid crystal display devices of the present embodiments are easy to produce and are capable of providing a high transmittance. The liquid crystal display device including the liquid crystal display panel can arbitrarily include members (for example, a light source and the like) included in a usual liquid crystal display device. However, the liquid crystal display panel of the present invention can provide a response speed that enables field sequential driving, and is especially preferably applied to a liquid crystal display device of field sequential driving. The liquid crystal display panel is also preferably applied to onboard display devices and liquid crystal display devices capable of stereoscopic vision (3D liquid crystal display devices).

With respect to the TFT substrate and the counter substrate, the electrode structure and others in the liquid crystal driving method and the liquid crystal display device of the present invention can be confirmed by microscopic observation with, for example, an SEM (scanning electron microscope). A driving voltage is verified by a usual method in the technical field of the present invention to make it possible to confirm the liquid crystal driving method of the present invention or the like.

The aforementioned modes of the embodiments may be employed in appropriate combination as long as the combination is not beyond the spirit of the present invention.

The present application claims priority to Patent Application No. 2011-229221 filed in Japan on Oct. 18, 2011 under the Paris Convention and provisions of national law in a designated State, the entire contents of which are hereby incorporated by reference.

### REFERENCE SIGNS LIST

10, 110, 210: Array substrate

11, 21, 111, 221: Glass substrate

13, 113, 213: Lower electrode

23, 123, 223: Counter electrode

15, 115, 215: Insulating layer

16, 116, 216: Pair of comb-shaped electrodes

17, 19, 117, 119, 217, 219: Comb-shaped electrode

20, 120, 220: Counter substrate

25: Overcoat layer

30, 130, 230: Liquid crystal layer

31: Liquid crystal (liquid crystal molecules)

33: Transverse electric field

37, 237: Region in which liquid crystal molecule are spray-aligned

39, 239: Line of electric force

D: Director

101a: Gate wiring

101b: Auxiliary capacitance wiring

101c: Connector

111g: Substrate

113i: Insulating film (gate insulating film)

105a, 105b: Oxide semiconductor layer (active layer)

107: Insulating layer (etching stopper, protection film)

109as, 109ad, 109b, 115b: Opening

111as: Source wiring

111ad: Drain wiring

111c, 117c: Connector

113p: Protection film

117 pix: Pixel electrode

201: Pixel part

202: Terminal arrangement region

T: Gate and source terminal

1-12. (canceled)

13. A liquid crystal display panel comprising:
a first substrate including a counter electrode and a dielectric layer;
a second substrate including a pair of comb-shaped electrodes and a lower electrode; and
a liquid crystal layer disposed between the first substrate and the second substrate, wherein
the pair of comb-shaped electrodes generate a transverse electric field in the liquid crystal layer,
the lower electrode is provided with a slit and,
a body of the lower electrode overlaps one of the pair of comb-shaped electrodes and the slit of the lower electrode overlaps the other of the pair of comb-shaped electrodes in a plan view of main surfaces of the first and the second substrates.

14. The liquid crystal display panel according to claim 13,
wherein at least part of an edge of the lower electrode does not overlap the pair of comb-shaped electrodes in a plan view of the main surfaces of the first and the second substrates.

15. The liquid crystal display panel according to claim 13,
wherein the lower electrode exists on a layer different from the layer on which the pair of comb-shaped electrodes exist.

16. The liquid crystal display panel according to claim 13,
wherein a thickness of the dielectric layer is 3.5 μm or less.

17. The liquid crystal display panel according to claim 13,
wherein the liquid crystal layer includes liquid crystal molecules which are aligned in the vertical direction to the main surfaces of the first and the second substrates at a voltage lower than a threshold voltage.

18. The liquid crystal display panel according to claim 13,
wherein the liquid crystal layer includes liquid crystal molecules having positive anisotropy of dielectric constant.

19. The liquid crystal display panel according to claim 13,
wherein the liquid crystal layer includes liquid crystal molecules having negative anisotropy of dielectric constant.

20. The liquid crystal display panel according to claim 13,
wherein at least one of the first substrate and the second substrate includes a thin film transistor element, and
the thin film transistor element includes an oxide semiconductor.

21. A liquid crystal display device, comprising the liquid crystal display panel according to claim 13.
